(19) United States
(12) Patent Application Publication
(10) Pub. No.: US 2019/0191926 A1
(43) Pub. Date: Jun. 27, 2019

(54) AUTOMATIC GRILLING SYSTEMS AND METHODS

(71) Applicant: Buckaroo Taco & Grill, LLC, Frisco, TX (US)

(72) Inventors: Juan Carrera GUERRERO, Torreon (MX); Ricardo Salazar RUBIO, Hermosillo (MX)

(21) Appl. No.: 15/850,110

(22) Filed: Dec. 21, 2017

(51) Int. Cl. A47J 37/04

(52) U.S. Cl. CPC A47J 37/045

(57) ABSTRACT

Methods and systems for automatically grilling meats and other food items comprise a movable grate and a plurality of burners that are controlled by a PLC-based control system. The control system automatically controls the speed of the movable grate and the temperature of the burners to automatically grill the meets and other food items. Additional components and equipment are provided that simulate the actions and steps that an operator must perform to produce grilled meats in the style of traditional grilling in a continuous manner over prolonged time periods with no interruption. Automation of processes such as seasoning, grilling, turning over and cutting meats, and grate cleaning are also provided. The above arrangement provides a number of environmentally friendly benefits, including lower fuel use, less contamination, and greater energy savings.

### FIELD OF THE INVENTION

The disclosed embodiments relate generally to systems and methods for automatic grilling meats and, in particular, to systems and methods for automatically controlling the temperature, duration, heat intensity, and other aspects of the meat grilling process.

### BACKGROUND OF THE INVENTION

Grilling is one of the most common forms of cooking meats. However, the grilling process involves much more than simply placing the meat over an open flame or heat source. Care must be taken to control the open flame or heat source to avoid under cooking, overcooking, or even burning the meat. It is equally important to ensure the meat remains on the open flame or heat source for the right amount of time and not too long or not long enough.

A traditional grill has a static grate or similar grilling surface and a means of heating, such as wood, charcoal, or gas based heat source. Recently, more complex grills have been develop that offer additional functionality, such as temperature control, automatic shut off, and the like. Some grills have been develop that can even help the operator clean out grilling waste and by-products from containment trays and the heating assembly.

While many advances have been made, it may be appreciated that improvements in grilling systems are continually needed.

### SUMMARY OF THE DISCLOSED EMBODIMENTS

The embodiments disclosed herein are directed to automated systems and methods for grilling any kind of meat. The automated grilling systems and methods use a moveable grate that resembles a conveyor belt to provide a moving grilling surface on which meat may be moved over a heat source. The systems and methods automatically control the speed of the moveable grate and the temperature of the heat source, which may be gas burners in some embodiments, based on operator selected settings. This helps ensure the meat is grilled for the desired amount of time and at the desired temperature, with little or no operator intervention. In addition, the automated grilling systems and methods disclosed herein can also perform such steps as seasoning, turning, cleaning of the grilling surface, and injection of oxygen for better combustion, among other things. In short, the systems and methods disclosed herein can simulate all the manipulations and steps that an operator would normally perform when grilling on a traditional grate or grill in order to impart to the meats the style of traditional grilling continuously and uninterruptedly over a protracted period. As well, the disclosed systems and methods can yield indirect benefits that are good for the environment, such as reduced use of fuel, reduced pollution, and increased energy savings.

Other aspects of the automated grilling systems and methods disclosed herein may include a PLC (programmable logic controller) based control system as well as various manual/mechanical devices and a touch-sensitive display that displays an HMI (human-machine interface) for controlling the system. A manual bypass system may be provided for manual start-up and operation of the system in the event of PLC failure. Still other aspects of the systems and methods may include an electric motor for automatically controlling the speed of the movable grate and automated seasoning system for automatically adding seasoning to the meat. Yet other aspects of the systems and methods may include an automated wheel-driven system for automatically cleaning the movable grate with a brush and a ventilation system with shutters for maintaining heat and smoke inside a ventilation hood. Still other aspects of the systems and methods may include strategically placed temperature sensors and an automated system for automatically turning on and off multiple gas burners according to daily demands so as to conserve energy and fuel.

Yet other aspects of the disclosed systems and methods may include a system for automatically adjusting the height of the burners in order to cook different types of meats. Selection of various dishes and cooking processes, which will take into account the duration of cooking and the thickness and type of cut (meat or vegetables), may be made through the touch-sensitive display and HMI. Still other aspects of the systems and method may include a weighing system that uses an electronic scale to weigh the finished product and provide feedback to the PLC. Yet other aspects of the systems and methods may include automated meat grinding equipment. A warming device may also be provided to keep the meat warm. Still other aspects of the systems and methods may include an alarm system for gas leaks and automatic shut-off and an automatic system for extinguishing fires in the event of a cut-off or gas leak. Yet other aspects of the systems and methods may include a light panel with various lights indicating when the system is operating, paused, or shut off, and also showing when there is a low supply of finished products and when there is an error or emergency.

In general, in one aspect, the disclosed embodiments relate to an automatic grilling system. The system comprises, among other things, a movable grate resembling a conveyor belt, the movable grate having a grilling area on which meats or other food items may be placed for grilling. The system also comprises a pair of horizontal parallel support rails supporting the movable grate, wheeled vertical support legs supporting the parallel support rails, and at least one axle extending through the pair of horizontal parallel support rails, the at least one axle having at least one sprocket mounted thereon, the at least one sprocket being engaged with the movable grate. The system further comprises an electric motor connected to the at least one axle and operable to rotate the at least one axle and the at least one sprocket mounted thereon to move the movable grate and at least one lower burner positioned directly underneath at least a portion of the grilling area of the movable grate. A control system is configured to control operation of the electric motor to automatically regulate a speed at which the movable grate is moved and further configured to control operation of the plurality of burners to automatically regulate an amount of heat provided by the burner.

In general, in another aspect, the disclosed embodiments relate to a method of automatically grilling meats or other food items. The method comprises, among other things, moving meats or other food items on a movable grate resembling a conveyor belt, the movable grate having a grilling area on which the meats or other food items may be placed for grilling. The also comprises operating at least one lower burner to provide heat to the meats or other food items being moved on the movable grate, the at least one lower burner positioned directly underneath at least a portion of the grilling area of the movable grate. The method further comprises automatically regulating a speed at which the movable grate is moved and automatically regulating an amount of heat provided by the burner.

### BRIEF DESCRIPTION OF THE DRAWINGS

The foregoing and other advantages of the disclosed embodiments may become apparent upon reading the following detailed description and upon reference to the drawings, wherein:

FIG. 1 is a perspective view of a grilling system according to some implementations of the disclosed embodiments;

FIG. 2 is a perspective view of a partially assembled grilling system according to some implementations of the disclosed embodiments;

FIG. 3 shows the exemplary grilling system with one or more burner assemblies being installed according to some implementations of the disclosed embodiments;

FIG. 4 is a side view of the exemplary grilling system according to some implementations of the disclosed embodiments;

FIG. 5 is a perspective view of an infrared burner according to some implementations of the disclosed embodiments;

FIG. 6 is a close up view of an exemplary burner assembly according to some implementations of the disclosed embodiments;

FIG. 7 is an internal view showing a gas line of the grilling system according to some implementations of the disclosed embodiments;

FIG. 8 is a close up view of the control panel according to some implementations of the disclosed embodiments;

FIG. 9 is a functional block diagram of an exemplary PLC according to some implementations of the disclosed embodiments; and

FIGS. 10-17 are screenshots of an exemplary user interface for the control panel according to some implementations of the disclosed embodiments.

### DETAILED DESCRIPTION OF THE DISCLOSED EMBODIMENTS

As an initial matter, it may be appreciated that the development of an actual, real commercial application incorporating aspects of the disclosed embodiments will require many implementation specific decisions to achieve the developer's ultimate goal for the commercial embodiment. Such implementation specific decisions may include, and likely are not limited to, compliance with system related, business related, government related and other constraints, which may vary by specific implementation, location and from time to time. While a developer's efforts might be complex and time consuming in an absolute sense, such efforts would nevertheless be a routine undertaking for those of skill in this art having the benefit of this disclosure.

It should also be understood that the embodiments disclosed and taught herein are susceptible to numerous and various modifications and alternative forms. Thus, the use of a singular term, such as, but not limited to, “a” and the like, is not intended as limiting of the number of items. Similarly, any relational terms, such as, but not limited to, “top,” “bottom,” “left,” “right,” “upper,” “lower,” “down,” “up,” “side,” and the like, used in the written description are for clarity in specific reference to the drawings and are not intended to limit the scope of the invention.

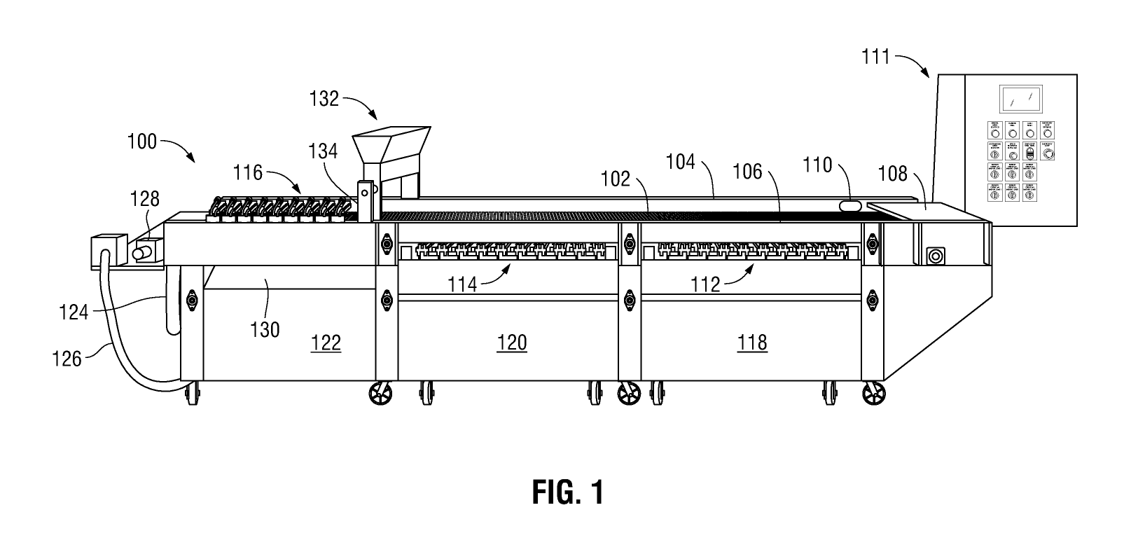

Referring now to FIG. 1, an automatic grilling system 100 is shown in accordance with the embodiments disclosed herein. As can be seen, the automatic grilling system 100 is composed primarily of a movable grate 102 that is mounted between two parallel support rails 104, 106. The movable grate 102 is made of stainless steel rods linked together and starts on the right-hand side of the grilling system 100 where a food preparation surface 108 has been installed and moves to the left. One or more sensors, indicated generally at 110, are mounted on one or both of the parallel support rails 104, 106 near the start of the movable grate 102 to detect when meats and other food items are placed on the movable grate 102. The sensors 110, which may be infrared sensors, photoelectric sensors, ultrasonic sensors, are monitored by a PLC (programmable logic controller) based control system, depicted generally at 111, that activates the movable grate 102 and other functions of the grilling system 100 when the presence of food items is detected.

Thereafter, the movable grate 102 automatically moves the food items at a user selected speed over one or more sets of burners underneath the grate 102. In the implementation shown here, there are two adjacent sets of burners 112, 114 underneath the grate 102 as well as a third set of burners 116 that is mounted over the grate 102 beyond the lower sets of burners 112, 114. There may of course be fewer or more sets of lower or upper burners, or even no upper burners, depending on the particular needs of the application. The lower sets of burners 112, 114 cook the food items from below while the upper set of burners 116 operate as a broiler to cook the food items from above. Each set of burners 112, 114, 116 is composed of several individual burners, which may be infrared gas burners in some embodiments or other suitable types of burners. The number of individual burners in each set may also vary depending on the particular needs of the application.

Removable cover panels 118, 120, 122 prevent easy access to and otherwise aesthetically conceal the interior areas of the grilling system 100 under the sets of burners 112, 114, 116, respectively. For example, there are connections underneath the sets of burners 112, 114, 116 for a main gas line 124 and an main electrical power line 126 in some embodiments that provide gas and electrical power, respectively, to the automatic grilling system 100. These connections should not be readily accessible. An emergency shut off switch 128 may be used to manually shut off electrical power to the grilling system 100 in case of emergency.

As well, the cover panels 118, 120, 122 may also hide removable grease trays, one of which can be seen at 130, mounted underneath each set of burners for catching and holding waste products, such as fats, meat juices, seasonings, and the like from the food items being grilled. These removable grease trays 130 facilitate cleaning of the grill system 100 since all waste generated falls into the trays 130 and may be removed and new trays 130 inserted without stopping the operation of the system 100. This makes it possible to grill continuously even when waste products from cooking or seasoning the meats need to be removed.

An automatic seasoning system may be provided on the grilling system 100 in some embodiments. The seasoning system may include a seasoning container 132 mounted over the movable grate 102 at any convenient location along the grate 102. In the example shown here, the seasoning container 132 is mounted between the second set of lower burners 112 and the upper set of burners 116. A vibration device 134 may be connected to the seasoning container 132 to produce vibrations on the container 132. The vibrations cause seasonings (e.g., salt, pepper, etc.) in the seasoning container 132 to pass through small holes or openings at the bottom of the container to simulate the movement of the hand of a cook adding salt or spices during cooking. The vibration device 134 may be connected to and activated (and deactivated) by the sensors 110 when the presence of meat is detected on the movable grate 102 so as not to waste ingredients and/or energy.

In some embodiments, a ventilating hood may be provided with grease catchers that are easily reached for cleaning purposes and hatches in the front part of the grill's workspace. This hood will have a slight forward slope at the bottom and grease-collecting ducts located inside the grill. The hood may be equipped with shutters so that smoke and heat will escape through the outer part of the grill in order to save electricity in the working area and maintain a pleasant working environment. All of this hardware may be connected to the PLC-based control system 111 to prolong the equipment's life span and save energy during down time.

In some embodiments, a weighing device may be provided comprising an electronic scale where the finished product comes out for weighing the finished product. The weighing device may send signals to the PLC-based control system 111 to control the entry and exit of ingredients and raw and cooked foods, as well as to turn the burners on and off according to demand.

In some embodiments, a device for warming the finished product may also be provided. For example, a ceramic-lined, stainless-steel container may be provided in the lower part of the movable grate 102, for maintaining heat. The warming device will run uniformly throughout the upper surface of the container and may be installed in the upper part of the weighing system. The device will control the temperature of the finished product in order to keep the product fresh and up to standard as long as possible. The device may be connected to the PLC-based control system 111 by means of sensors and a programming system.

An alarm system for gas leaks and automatic shut-off may also be provided in some embodiments. For example, serve gas detectors may be installed in the upper and lower parts of the grill. When the sensors detect a possible fuel leak, they will send a signal to the PLC-based control system 111 to close one of the main safety valves that supply gas to the grilling system 100.

As well, an automatic system for extinguishing fires in the event of a cut-off or leak of gas may be provided in some embodiments. If fire is detected outside the area of the burners, this system may automatically issue an audible warning to alert the operator so the operator can address the problem, for example, by hitting the emergency shut off button 128. If the operator does not press the emergency shut-off button 120, which is located 1.80 cm from the front and the back of the grill, the extinguishers automatically release a chemical agent to extinguish the fire.

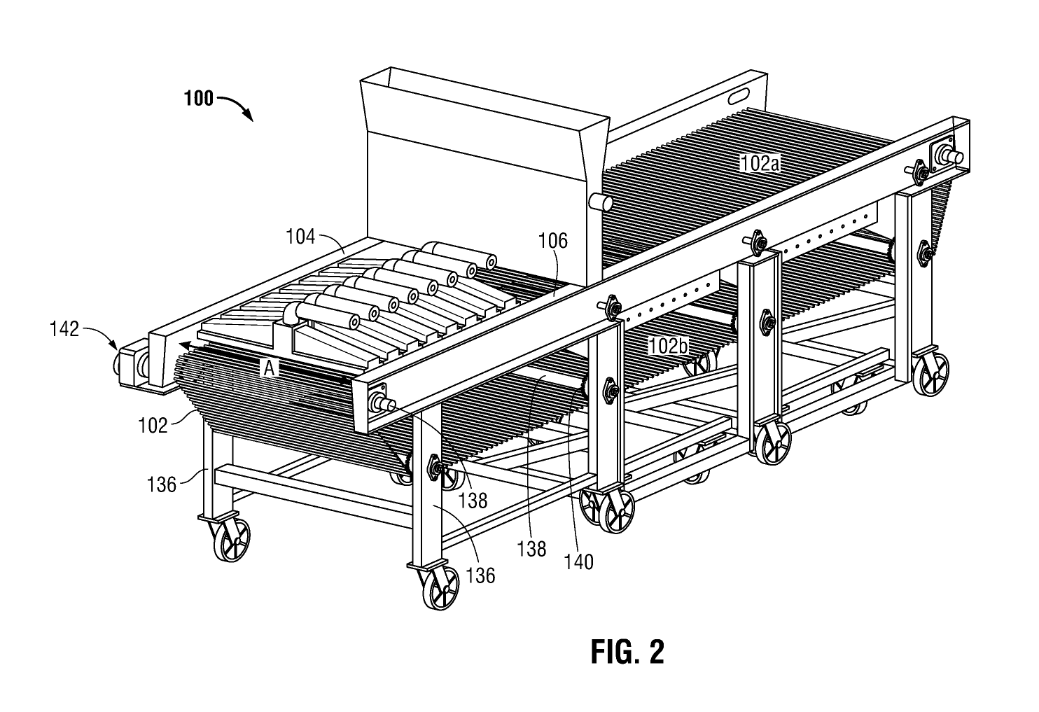

FIG. 2 illustrates the grilling system 100 in a partially assembled state. In this view, the movable grate 102 can be seen as resembling a conveyor belt having a width “A” supported between the horizontal parallel guides 104, 106. The width “A” of the movable grate 102 may be selected as needed and may be, for example, from 12 inches to 24 inches or more. The horizontal guides 104, 106 are in turn supported on a plurality of wheeled vertical support legs, one of which is indicated at 136. In the example shown here, there are four pairs of evenly spaced vertical support legs 136 supporting the horizontal guides 104, 106. Each pair of vertical support legs 136 has an axle 138 extending therethrough and sprockets 140 mounted thereon that engage a lower portion 102b of the movable grate 102. Similar combinations of axles 138 and sprockets 140 extend through the guides 104, 106 and engage an upper portion 102a of the movable grate 102. This upper portion 102a comprises the grilling area where meats and other food items may be placed and grilled. The axles 138 and sprockets 140 maintain tension in the movable grate 102 and facilitate conveyer-like movement of the movable grate 102.

An electric motor 142 may be attached to one of the axles 138, for example, the leftmost axle, to rotate the moveable grate 102. Any suitable electric motor 142 known to those skilled in the art may be used. The motor 142 rotates the axle 138, which turns the sprockets 140 mounted thereon to convert rotational motion from the motor to linear motion on the moveable grate 102. The speed of the motor may be controlled automatically by the PLC-based control system 111 mentioned earlier as well as by manual control in some embodiments, such as by turning a knob on the motor 142 with speed settings from 1 to 10, for example. An overcurrent protection system (not expressly shown), such as a fuse, circuit breaker, or other current limiting device known to those skilled in the art, may be provided to automatically shut off the motor 142 in the event of a sudden increase in current.

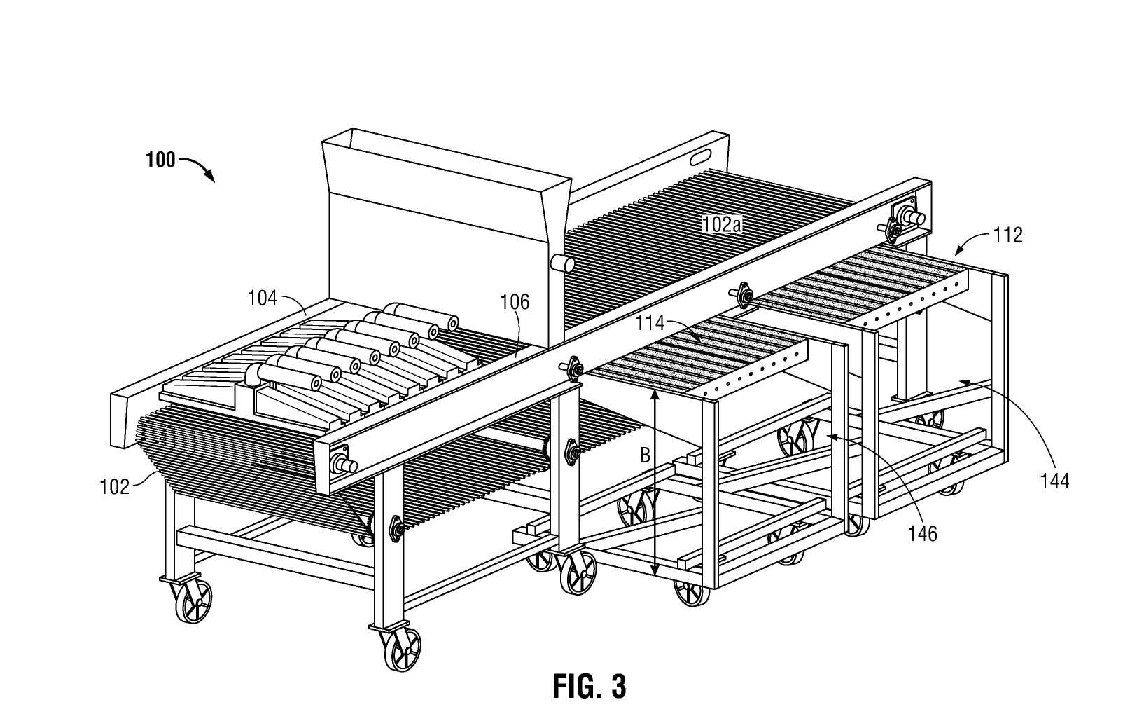

FIG. 3 illustrates the grilling system 100 with the two sets of lower burners 112, 114 being installed. As can be seen, each of the sets of lower burners 112, 114 are bracketed or otherwise mounted to wheeled burner assemblies 144, 146, respectively, which are shown here in a partially assembled state. The wheeled burner assemblies 144, 146 allow the sets of lower burners 112, 114 to be easily rolled underneath the movable grate 102 where they may be locked or otherwise secured to the vertical support legs 136 using an appropriate locking mechanism.

In some embodiments, a height adjustment mechanism may be provided on the burner assemblies 144, 146 for automatically adjusting a height “B” of the lower burners 112, 114 relative to the upper portion 102a of movable grate 102. For example, a mechanical device located in the lower part of the grill will function as a nest for the lower burners 112, 114. This nest will use a metallic structure in which 4 axial bearings are installed. These bearings may be mounted in two Thomson rods located in the fixed base. Together with the power reducer, a chain, a pair of cogwheels, and a few sensors, they will allow for setting the various heights needed for cooking anything from salmon to a one-inch T-bone steak. All of these combinations may be provided on the menu for selecting the dish to prepare.

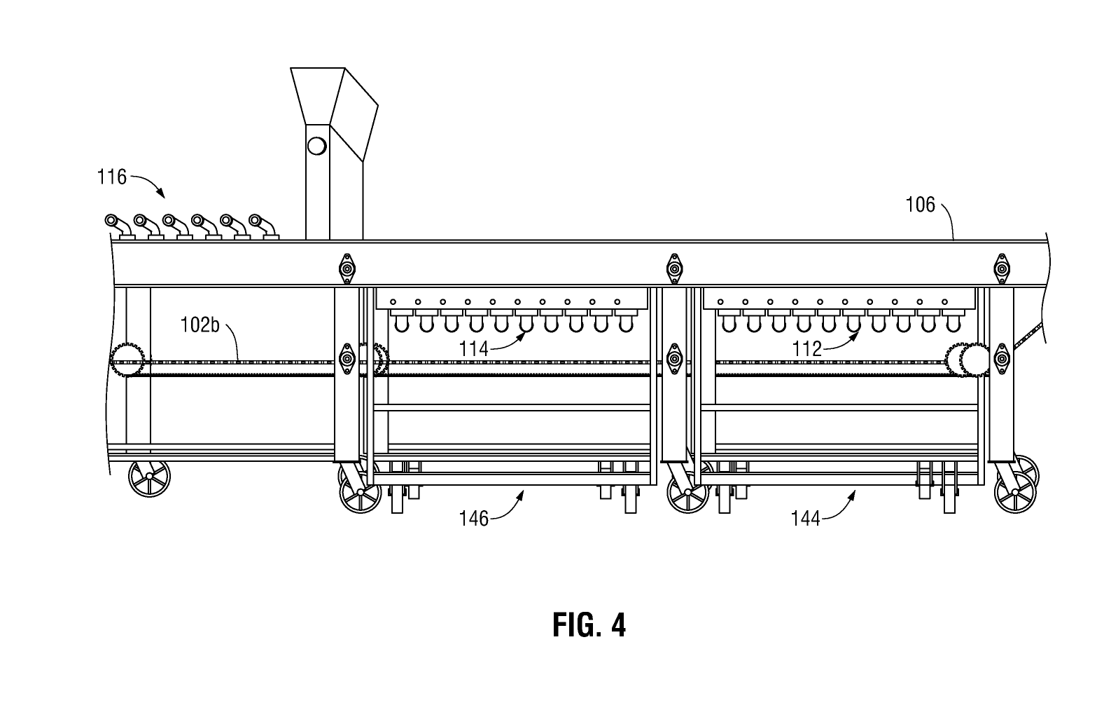

FIG. 4 illustrates the grilling system 100 with the burner assemblies 144, 146 and the sets of lower burners 112, 114 installed and secured therein. As mentioned earlier, the individual burners making up the lower burners 112, 114 and upper burners 116 may be infrared gas burners. Such infrared gas burners are commercially available from, for example, Imperial Commercial Cooking Equipment of Corona, Calif.

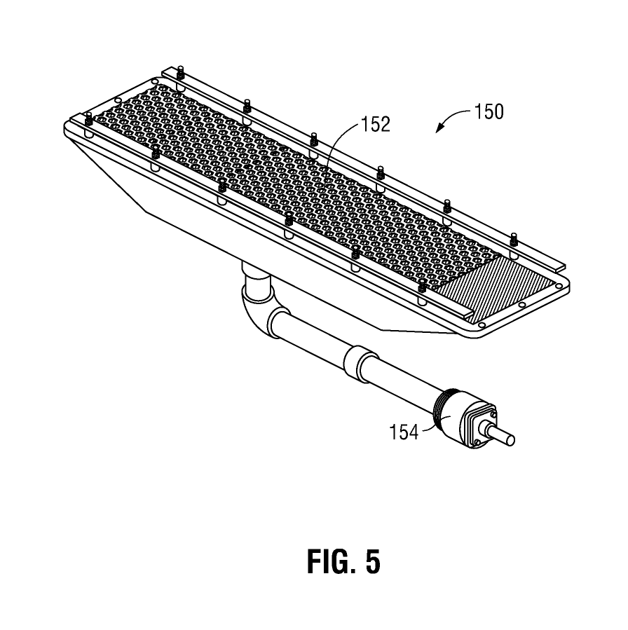

FIG. 5 shows an example of a commercially available individual infrared gas burner at 150. Burners like the burner 150 typically have a stainless steel mesh 152 covering them to protect the burner ceramic and to disperse heat evenly. These burners typically also have valves 154 to regulate gas and air entry for combustion, rapidly bringing the temperature up to an optimal level in which to begin cooking the meat. If there are periods of inactivity, the valves 154 make it possible to turn the burners off without risking losing the conditions needed to quickly start grilling meat again when required. This is of great benefit if there are set periods of time during which the grill is not required. Other types of burners may of course be used without departing from the scope of the disclosed embodiments.

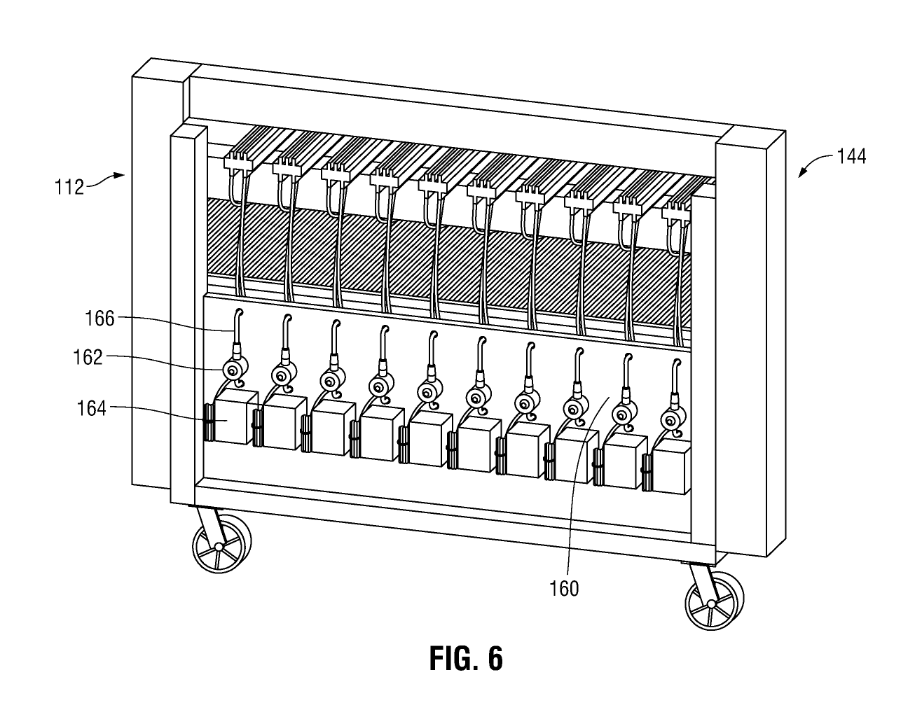

FIG. 6 is a close-up view of one of the burner assemblies, specifically burner assembly 144, in an assembled state with the set of lower burners 112 bracketed or otherwise mounted to the assembly 144. An interior panel 160 is also mounted to the burner assembly 144 for supporting a plurality of solenoid valves 162 and valve control units 164 for the solenoid valves 162. Each solenoid valve 162 regulates the supply of gas to one individual burner in the set of lower burners 112 via an individual gas line 166 connected to each burner, and each valve control unit 164 controls the opening and closing of one solenoid valve 162. The valve control units 164 are in turn connected to and may be controlled automatically by the PLC-based control system 111 mentioned in FIG. 1 to adjust the amount of gas supplied to each individual burner.

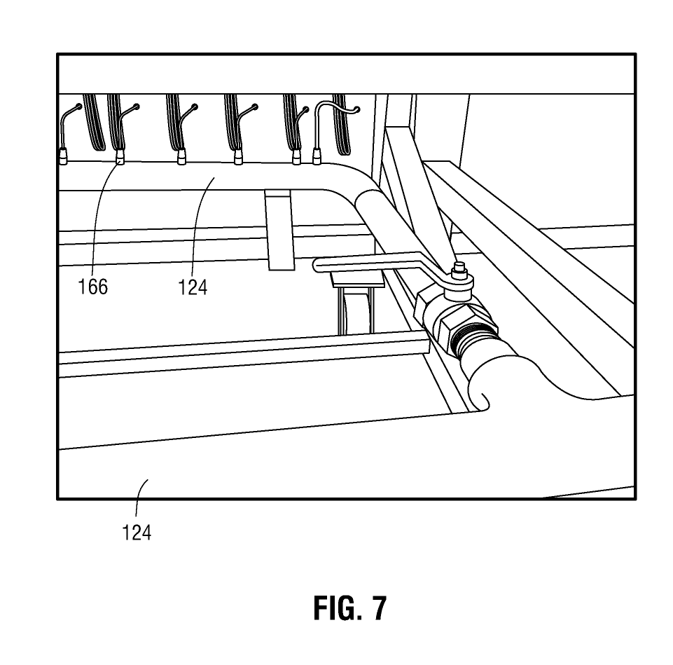

FIG. 7 is an interior view showing the routing of the main gas line 124 from FIG. 1 internally within the grilling system 100. The individual gas lines 166 may then be connected to the main gas line 124 to provide gas to the various burners.

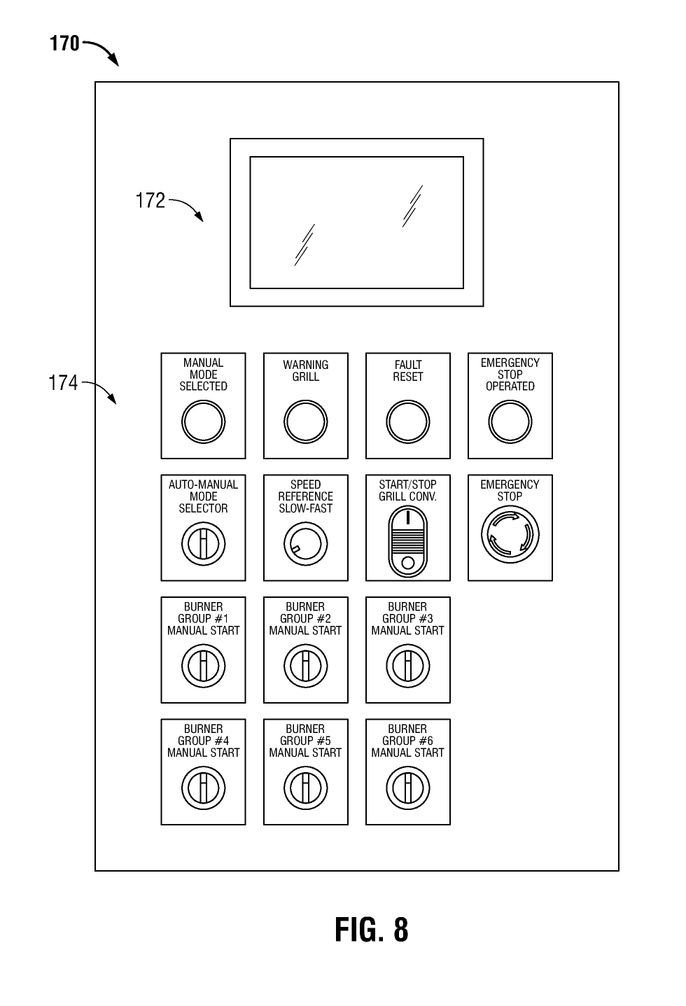

FIG. 8 illustrates a control panel 170 that may be used with the PLC-based control system 111 mentioned in FIG. 1. As can be seen, the control panel 170 includes a touch-sensitive display 172 that may be used to display a human-machine interface (HMI) to allow an operator to select the various variables and functions of the grilling system 100 implemented by and incorporated into the PLC. As may be discussed further herein, this display 172 displays a menu of the grill's various variables and functions of the grilling system 100, including dishes to be cooked, programming, maintenance, temperature, speed, and intensity of flames, as well as any errors that may occur during operation.

In addition to the touch-sensitive display 172, the control panel 170 may include a plurality of indicator lights and mechanical controls for manual operation of the grilling system 100. For example, in the first row going from left to right, there may be a manual mode light for indicating that manual operation has been selected, a warning light for indicating an error has occurred, a reset button for resetting the grilling system 100, and an emergency light for indicating that an emergency stop has been initiated. In the second row, there may be an auto-manual selector knob for selecting between manual operation and automatic operation, a speed control knob for selecting the speed of the movable grate 102, a start/stop button for starting and stopping the movable grate 102, and an emergency stop button for shutting off all power to the grilling system 100. The third and fourth rows include knobs for controlling the operation of individual burners or groups of burners as may be defined for the particular application. For example, each set of lower burners 112, 114 may be evenly subdivided into two groups of burners (e.g., groups 1 & 2 and groups 3 & 4), while the set of upper burners 116 may also be evenly subdivided into two groups of burners (e.g., groups 5 & 6)

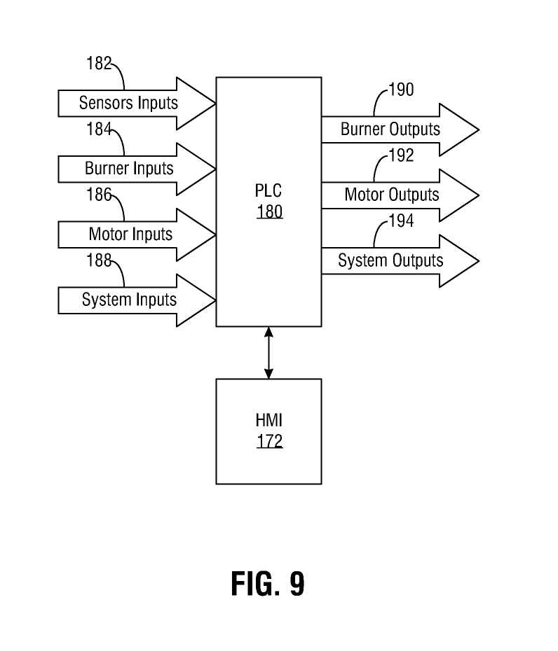

FIG. 9 is a functional block diagram illustrating a PLC 180 that may be used for the PLC-based control system 111 to automatically operate the grilling system 100, for example, when the auto-manual selector knob has been turned to auto. PLCs like the PLC 180 are generally well known to those skilled in the art and therefore a detailed description is omitted here. Suffice it to say, PLCs like the PLC 180 are designed to receive a plurality of inputs, including analog and digital inputs, and provide one or more outputs according to their programming. In the example shown here, the PLC 180 may receive a plurality of sensor inputs 182, including proximity sensor inputs, temperature sensor inputs, weight sensor inputs, and the like. The PLC 180 may also receive a plurality of burner inputs 184, such as whether a burner is on or off and the amount of gas being supplied to the burner. As well, the PLC 180 may further receive a plurality of motor inputs 186, including whether the electric motor 142 is on and how fast it is rotating, whether the vibrating device 134 is on and how fast it is vibrating, and the like. A plurality of system inputs 188 may also be provided to the PLC 180, including operational status, any error messages, and the like. Based on these inputs, the PLC 180 may provide a plurality of outputs according to its programming, including outputs 190 for controlling the burners, outputs 192 for controlling the electric motor and the vibrating device, and system related outputs 194, such as system shut off and the like.

As an example, the PLC 180 may be programmed to automatically turn on and off the infrared burners so as to conserve energy and fuel may be provided using sensor signals from certain sensors (e.g., sensors 110) connected to the PLC-based control system 111. The PLC 180 may turn the burners on and off in order to save fuel and electricity, thus benefiting the environment as well. In some embodiments, the PLC 180 makes it possible so that approximately 1.5 minutes after the burners are lighted, they may be ready for cooking any of the foods listed on the menu. If no food is detected approximately 2 minutes following the 1.5 minutes after the burners are lighted, they may be turned off automatically, which detect the presence or absence of food on the movable grate 102. The PLC 180 may also be connected to the weighing system mentioned earlier, which may send two signals for turning the burners on and off: one to turn the burners on when there is a shortage of cooked meat, another when there is an abundance of cooked meat, taking into account the meat cooking on the grill.

In some embodiments, the PLC 180 may be programmed or otherwise set to turn on multiple burners according to the day's demand. As an example, the PLC 180 may function as follows: on Tuesday, ordinarily a day with low sales, the PLC 180 may use 8 lower burners and 3 upper burners, with a speed that produces 5 kg of meat every 5 minutes. For sales on Sunday, on the other hand, the PLC 180 may be programmed or otherwise set to use 20 lower burners and 8 upper burners at a speed that produces 5 kg of meat per minute.

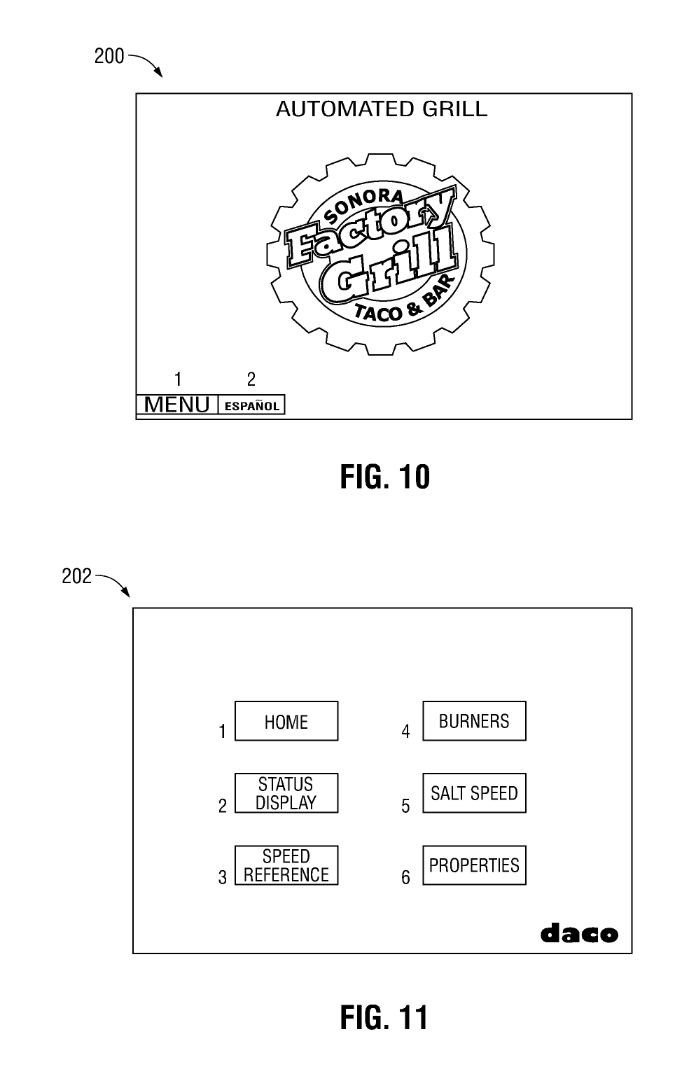

Setting of the PLC 180 may be accomplished through a touch-screen HMI 172, an example of which is shown in FIGS. 10-17.

Referring to FIG. 10, the HMI 172 may include a home screen 200 and from which various menu options may be accessed by selecting a menu option (1). A Spanish language option is also accessible by selecting a Spanish option (2) on the home screen 200.

FIG. 11 shows a main menu screen 202 resulting from the selection of the menu option on the home screen 200. In this menu screen 202, various options are available, including a home option (1) that returns the operator to the previous home screen 200, a status option (2) where the operator can see the status of the grilling system, a speed option (3) where the operator can set the speed of the movable grate 102, a burner control option (4) where the operator can control the operation of the burners, a salt speed option (5) for controlling the operation of the seasoning system, and a properties option (6) where the user can set system properties such as a shut off time.

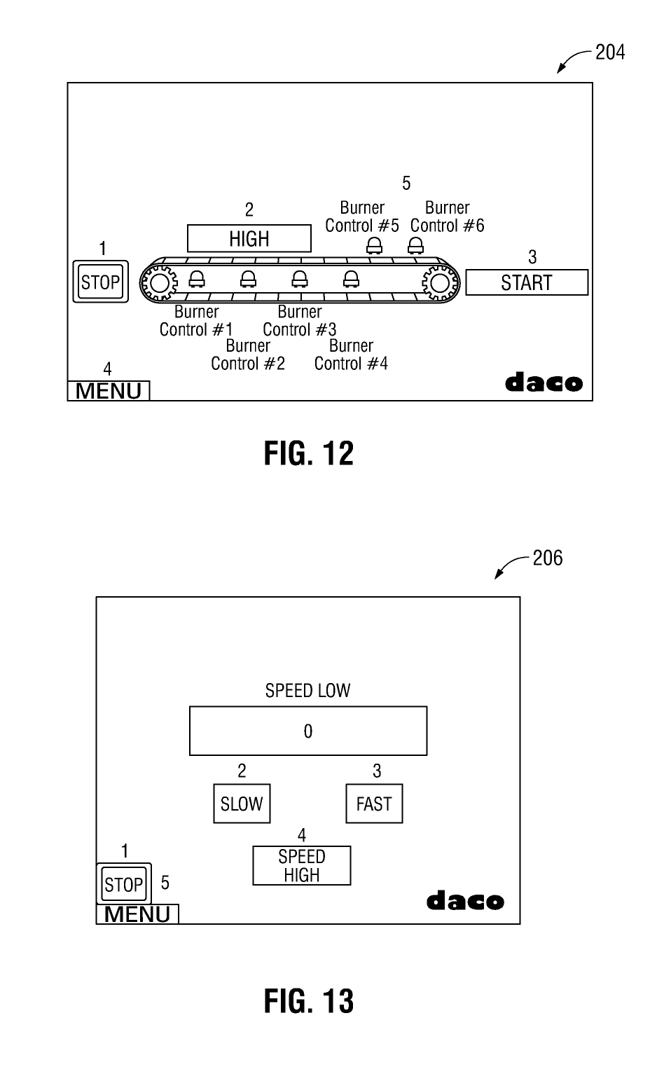

FIG. 12 shows a status screen 204 resulting from the selection of the status option on the menu screen 202. In this status screen 204, there is a stop option (1) that automatically disables all currently running processes, a lower burner capacity option (2) that allows the operator to select how many groups of lower burners to turn on, and an upper burner capacity option (5) that allows the operator to select how many groups of upper burners to turn on. Selecting the start option (3) activates selected burners and selecting the menu option (4) returns the operator to the main menu screen 202.

FIG. 13 shows a speed screen 206 resulting from the selection of the speed option on the menu screen 202. In this speed screen 206, there is again a stop option (1) that automatically disables all currently running processes, a slow option (2) that incrementally decreases the speed of the movable grate, and a fast option (3) that incrementally increases the speed of the movable grate. The current speed of the movable grate is displayed numerically and descriptively above the slow option (2) and the fast option (3). As can be seen, the movable grate is currently in low speed mode, indicating the grilling system is currently in low-demand mode. Selecting a high-speed option (4) sets the speed of the movable grate to high speed. Selecting the menu option (4) again returns the operator to the main menu screen 202.

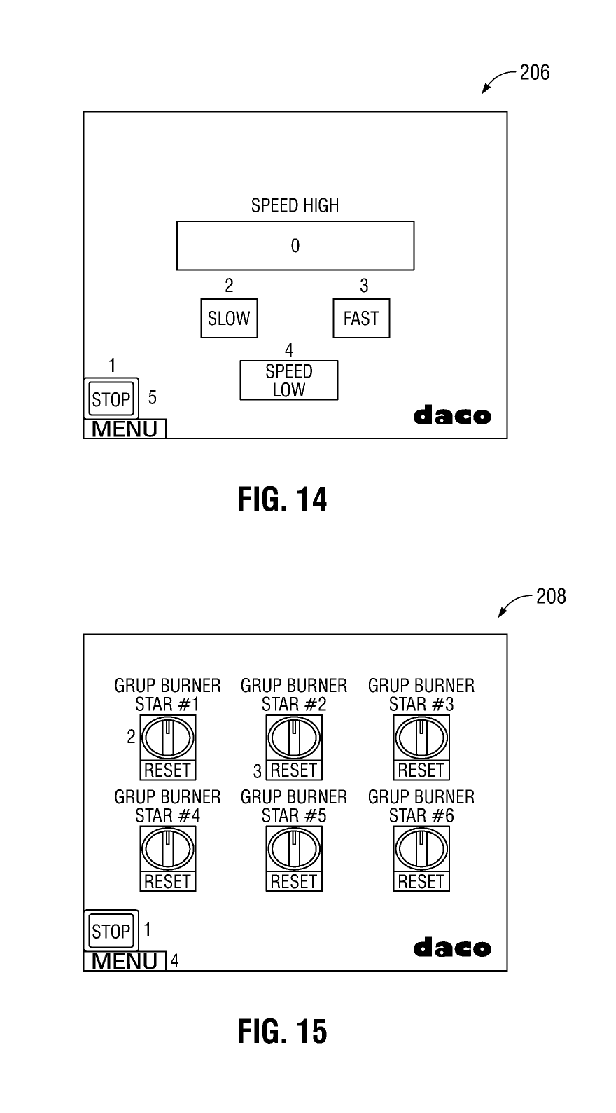

FIG. 14 shows the same speed screen 206 from FIG. 13, but with the movable grate in high-speed mode. Speed screen 206 resulting from the selection of the speed option on the menu screen 202. As before, selecting the slow option (2) incrementally decreases the speed of the movable grate, and selecting the fast option (3) incrementally increases the speed of the movable grate. Again, the current speed of the movable grate is displayed numerically and descriptively above the slow option (2) and the fast option (3).

FIG. 15 shows a burner control screen 208 resulting from the selection of the burner control option on the menu screen 202. Here again a stop option (1) automatically disables all currently running processes and a menu option (4) returns the operator to the main menu screen 202. The remaining buttons on this screen 208 allow the operator to manually reset or restart any of the burner groups in case any of the burners in one of the groups is inadvertently turned off.

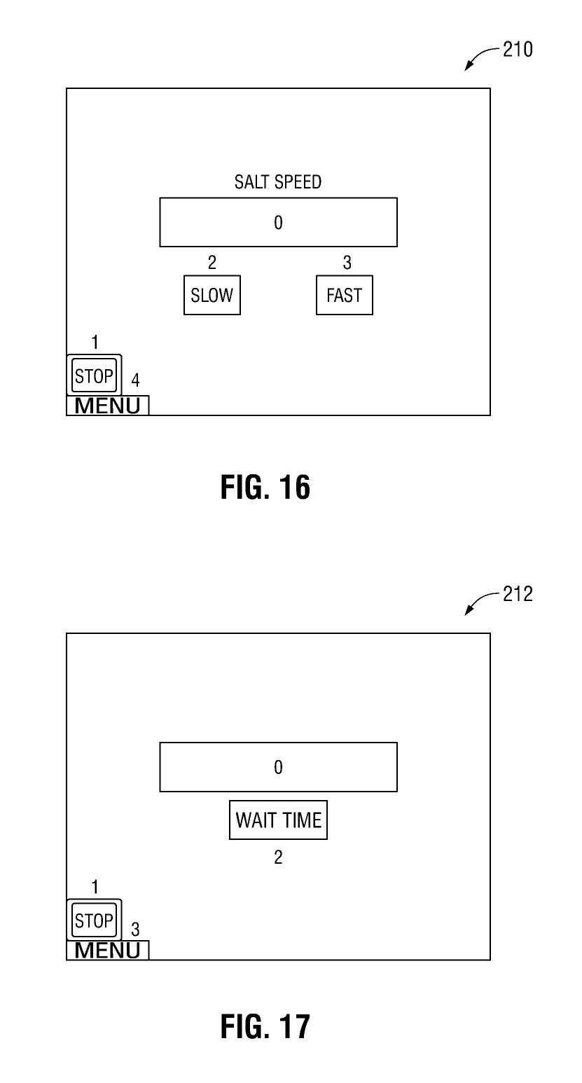

FIG. 16 shows a salt speed screen 210 resulting from the selection of the salt speed option on the menu screen 202. From the screen 210, the operator may select a slow option (2) that incrementally decreases the speed of the seasoning system, and a fast option (3) that incrementally increases the speed of the seasoning system. The current speed of the seasoning system is displayed numerically and descriptively above the slow option (2) and the fast option (3). Selecting a stop option (1) automatically disables all currently running processes and selecting a menu option (4) returns the operator to the main menu screen 202.

FIG. 17 shows a properties screen 212 resulting from the selection of the properties option on the menu screen 202. From the screen 212, the operator may set a delay time for the grilling system to automatically turn off. This is equivalent to manually pressing the emergency stop button 128 mentioned earlier. Selecting a stop option (1) automatically disables all currently running processes and selecting a menu option (4) returns the operator to the main menu screen 202.

While particular aspects, implementations, and applications of the present disclosure have been illustrated and described, it is to be understood that the present disclosure is not limited to the precise construction and compositions disclosed herein and that various modifications, changes, and variations may be apparent from the foregoing descriptions without departing from the spirit and scope of the disclosed embodiments as defined in the appended claims.

What is claimed is:

1. An automatic grilling system, comprising:
a movable grate resembling a conveyor belt, the movable grate having a grilling area on which meats or other food items may be placed for grilling;
a pair of horizontal parallel support rails supporting the movable grate;
wheeled vertical support legs supporting the parallel support rails;
at least one axle extending through the pair of horizontal parallel support rails, the at least one axle having at least one sprocket mounted thereon, the at least one sprocket being engaged with the movable grate;
an electric motor connected to the at least one axle and operable to rotate the at least one axle and the at least one sprocket mounted thereon to move the movable grate;
at least one lower burner positioned directly underneath at least a portion of the grilling area of the movable grate; and
a control system configured to control operation of the electric motor to automatically regulate a speed at which the movable grate is moved and further configured to control operation of the plurality of burners to automatically regulate an amount of heat provided by the burner.

2. The grilling system of claim 1, wherein the control system is a programmable logic controller based control system.

3. The grilling system of claim 1, further comprising at least one upper burner positioned directly above at least a portion of the grilling area of the movable grate.

4. The grilling system of claim 3, further comprising at least one solenoid valve, each solenoid valve connected to an individual burner and configured to regulate a supply of gas to the individual burner.

5. The grilling system of claim 4, further comprising at least one valve control unit, each valve control unit connected to a solenoid valve and operable by the control system to open and close the solenoid valve.

6. The grilling system of claim 1, further comprising a seasoning system positioned above the movable grate and operable by the control system to season the meats or other food items on the movable grate.

7. The grilling system of claim 1, wherein the control system includes a human-machine interface configured to allow an operator to select the number of burners to turn on and the control system automatically turns on the selected number of burners.

8. The grilling system of claim 7, wherein the human-machine interface further allows an operator to set the speed of the movable grate and the control system automatically adjusts the speed of the movable grate to the selected speed.

9. The grilling system of claim 1, wherein the control system includes mechanical controls for allowing an operator to manually turn on a selected number of burners.

10. The grilling system of claim 9, wherein the control system includes mechanical controls for allowing an operator to manually adjusts the speed of the movable grate.

11. A method of automatically grilling meats or other food items, comprising:
moving meats or other food items on a movable grate resembling a conveyor belt, the movable grate having a grilling area on which the meats or other food items may be placed for grilling;
operating at least one lower burner to provide heat to the meats or other food items being moved on the movable grate, the at least one lower burner positioned directly underneath at least a portion of the grilling area of the movable grate; and
automatically regulating a speed at which the movable grate is moved and automatically regulating an amount of heat provided by the burner.

12. The method of claim 11, wherein regulating the speed at which the movable grate is moved and regulating the amount of heat provided by the burner is performed by a programmable logic controller based control system.

13. The method of claim 11, further comprising operating at least one upper burner to provide heat to the meats or other food items being moved on the movable grate, the at least one upper burner positioned directly above at least a portion of the grilling area of the movable grate.

14. The method of claim 13, further comprising automatically controlling at least one solenoid valve, each solenoid valve connected to an individual burner, to regulate a supply of gas to the individual burner.

15. The method of claim 14, further comprising automatically operating at least one valve control unit, each valve control unit connected to a solenoid valve, to control the solenoid valve.

16. The method of claim 11, further comprising automatically seasoning the meats or other food items on the movable grate.

17. The method of claim 11, further comprising allowing an operator to select the number of burners to turn on using a human-machine interface and automatically turning on the selected number of burners.

18. The method of claim 17, further comprising allowing an operator to set the speed of the movable grate using the human-machine interface and automatically adjusting the speed of the movable grate to the selected speed.

19. The method of claim 11, further comprising allowing an operator to manually turn on a selected number of burners using mechanical controls.

20. The method of claim 19, further comprising allowing an operator to manually adjust the speed of the movable grate using mechanical controls.
